(19) United States
(12) Patent Application Publication
(10) Pub. No.: US 2016/0229972 A1
(43) Pub. Date: Aug. 11, 2016

(54) FOAM PRODUCTS AND METHODS OF PRODUCING THE SAME

(71) Applicant: ROGERS CORPORATION, Rogers, CT (US)

(72) Inventor: Kurt C. Frisch, JR., Woodstock, CT (US)

(21) Appl. No.: 15/016,414

(22) Filed: Feb. 5, 2016

Related U.S. Application Data
(60) Provisional application No. 62/112,282, filed on Feb. 5, 2015.
(60) Provisional application No. 62/263,104, filed on Dec. 4, 2015.

(51) Int. Cl. C08J 9/08; C08G 18/48; C08G 18/22; C08G 18/08; C08G 18/76; C08G 18/34

(52) U.S. Cl. CPC C08J 9/08; C08G 18/7671; C08G 18/341; C08G 18/345; C08G 18/225; C08G 18/14; C08G 18/4883; C08J 2375/08; C08J 2375/06; C08J 2203/06

(57) ABSTRACT

Compositions for the formation of heat resistant foams are disclosed. The invention also relates to a process for the production of polymeric foams containing amide groups with foaming substantially accomplished by elimination of carbon dioxide by reaction of polyfunctional isocyanates, carboxylic acids, and polyols in the presence of a catalyst system composition comprises a catalyst compound having a cation of a metal, in a salt or ligand, which metal is selected from the group consisting of magnesium, cobalt, manganese, yttrium, Lanthanide Series metals, and combinations thereof, resulting in formation of amide groups in the polymer.

### FIELD

This invention relates generally to thermally stable polymer foams. More particularly, this invention relates to tough, heat resistant polyamide-urethane foam material. This invention also relates to a process for the production of such foam materials by catalytic reaction of polyfunctional carboxylic acid, isocyanate, and hydroxy compounds with formation of carbon dioxide.

### BACKGROUND

It is known that carboxy groups in a carboxylic acid can give off carbon dioxide when reacted with isocyanates and can thus contribute towards a blowing reaction in the production of polyamide materials. Depending on the particular reactants and process conditions, competing side reactions can produce various products and intermediate products.

The use of the NCO/COOH (isocyanate/acid) reaction to produce foaming is potentially desirable, because it would allow a more efficient and lower cost way of generating carbon dioxide for foaming than the standard water/isocyanate reaction used in the manufacture of polyurethanes. This is because it takes only one equivalent of isocyanate and one equivalent of acid to produce an equivalent of carbon dioxide. In contrast, the standard foaming reaction for polyurethane foams, involving a water/isocyanate reaction, requires two equivalents of isocyanate (which is an expensive component) to produce one equivalent of carbon dioxide.

Furthermore, polyamides are generally known for their comparatively good thermal stability. Heat resistant polymer foams are, therefore, useful materials for a wide variety of applications, particularly in the automotive and electronic industries.

The use of carboxylic acids as blowing agents for polyamide systems, however, has been attended by disadvantages including, for example, the use of relatively high temperatures, inadequate blowing effect, incomplete reactions, and the inadequate properties of the resulting product, as noted in US Patent Publication 2013/0225708. Thus, there have been obstacles to industrial application. Further improvement or developments are desired, therefore, in order to be use the NCO/COOH reaction to produce a commercial foam polymer product.

It is important, however, that polymer foams have, in addition to thermal stability, acceptable physical or mechanical properties such as compression set, abrasion resistance, flex resistance, tear strength, and the like. In other words, it is desirable that improved heat resistance is not at the expense of other necessary or desirable properties, resulting in undesirable properties such as friability or susceptibility to hydrolysis.

The following patents and published applications describe the formation of polymeric foam by the reaction of a carboxylic acid, an isocyanate, and a polyol in the presence of a catalyst. It should be noted, however, that the resulting product and its properties may depend on, among various factors such as the specific reactants present, the relative amounts thereof, and the order of mixing, the catalyst, and the reaction temperature.

US 2013/0225708 to Prissok et al. discloses a process of producing a rigid polymer foam by reacting polyisocyanate, polyol, and polycarboxylic acid in the presence of a Lewis base, with release of carbon dioxide. Preferably the polyol is a polyether polyol or polyester polyol (paragraph 0028). The Lewis base is, for example, N-methylimidazole. According to Example 1 of Prissok et al., a diacid is melted into a polyol with a basic catalyst present, which is believed to most likely produce an esterification reaction with water as a by-product that would also react with the polyisocyanate to produce carbon dioxide similar to the amide/isocyanate reaction.

U.S. Pat. No. 5,527,876 discloses polymer foam that is produced by reacting polyfunctional isocyanates, carboxylic acids, and optionally alcohols in the presence of tertiary amines. Various alcohols, including fatty acid dimers, are listed in col. 8, lines 3-54. In addition to amines listed in col. 10, lines 3-58, additional catalysts are listed in col. 11, lines 20-31, including tin and lead salts. The products are described as plastics containing amide groups.

U.S. Pat. No. 3,562,189 discloses high temperature resistant polymers that are prepared by admixing, at ambient temperatures, a polycarboxylic anhydride with an organic polyisocyanate in an aprotic solvent. An “adjuvant III” containing active hydrogen atoms, inclusive of polyols, is described in col. 7, line 68, to col. 10, line 22. The polyols include polyoxyalkylene glycols, polyether glycols, and the like. A polyester glycol is listed in col. 9, line 72. Water is mentioned as an additional foaming agent, but is not used in the examples. Catalysts are listed in col. 10, lines 53-9 and include cobalt and tertiary organic amines. Most of the examples refer to the production of polyimide involving the reaction of a polycarboxylic acid, anhydride, and diisocyanate. Example 12 produced a polyamide foam.

U.S. Pat. No. 3,637,543 discloses thermally stable foams that are prepared by reacting, without the addition of external heat, a polyfunctional aromatic carboxylic acid with a polyarylpolyisocyanate and a polyol containing at least three hydroxyl groups. In an alternate embodiment, a modified polyurethane self-foaming resin employs polyols in the presence of a catalytic amount of water. Polyols are listed in col. 5, lines 39-75, including oxypropylene and oxyethylene adducts. Catalysts include amines and organo-tin compounds. For example, a polyether polyol, trimellitic acid, polyisocyanate, and tin diacetate were employed in Example 14. In col. 6, lines 33-41, the patent states that it appears that when the polyol, liquid polyarylisocyanate and polyfunctional aromatic acid derivatives are mixed together, the reaction of polyol and polyarylpolyisocyanate proceeds rapidly to produce a polyurethane moiety, whereas the reactions to produce polyamide-imide are slower. Although the invention provides thermally stable foams, aromatic acids are required. The patent states that when aliphatic acids are employed, the foams in many instances support a flame and, when polyols having a molecular weight in excess of 2000 are used, the resulting foams tend to lose their flame resistance.

U.S. Pat. No. 4,975,514 discloses a polyisocyanate composition containing an amide-modified product that is produced from the reaction of a polyisocyanate with a polybasic carboxylic acid. This composition can be reacted with a polyol, including a polyether polyol, as stated in col. 4, lines 27-46. The patent further states that the composition is particularly suitable as a starting material for a polyurethane polymer such as polyurethane or polyurethane urea. Example 7 uses a polycaprolactone triol. The product is described as a polyurethane and uses a relatively low ratio of acid groups and excess isocyanate, col. 2, lines 30-44. Thus, the polyamide is avoided and foams do not result. Tin catalysts are used in the examples.

US 2010/0022717 discloses the manufacture of isocyanate-terminated polyamides by reaction of a carboxyl-terminated polyamide with an excess of isocyanate in the presence of a catalyst, e.g., magnesium stearate (paragraph 0066). High temperatures are used and foams are not mentioned, although generation of carbon dioxide is mentioned (paragraph 0138). Organotin catalysts are mentioned on page 7, paragraph 0108. Cobalt and other metal salts are also mentioned.

There remains a need for a polymer foam composition with improved thermal stability, for example, compared to current polyurethane foam products. Furthermore, it would be desirable to obtain an improved process of manufacture that allows a more efficient and lower cost way of generating carbon dioxide for the foaming reaction than the standard water/isocyanate reaction, and, at the same time, would provide a commercially useful product having improved properties compared to prior art foam products involving the NCO/COOH reaction. It would be desirable, during the manufacture of such foam products, to effectively carry out the reaction at room temperature or at an elevated temperature, for example, at a temperature not greater than 100° C., as in current polyurethane production processes.

### SUMMARY

The above-discussed and other drawbacks and deficiencies of the prior art are overcome or alleviated by a foam product formed from a foamable composition comprising an organic polyisocyanate component; a polyacid component substantially reactive with the polyisocyanate to form an amide group in a resulting polyamide-urethane copolymer; a polyol component substantially reactive with the polyisocyanate compound to form a urethane group in the polyamide-urethane copolymer; a surfactant composition component; and a catalyst system composition having substantial catalytic activity in the curing of said foamable composition, wherein the catalyst system composition comprises a catalyst compound comprising a cation of a metal, in a salt or ligand form, which metal is selected from the group consisting of magnesium (specifically Mg⁺²), cobalt (specifically Co⁺²), yttrium (specifically Y⁺³), manganese (specifically Mn⁺²), and Lanthanide Series metals (for example, Lanthanum, specifically La⁺³, Neodymium, specifically Nd⁺³, and Dysprosium, specifically Dy⁺³ or the like), and combinations thereof, wherein the curing reaction is associated with the elimination of carbon dioxide derived from a carboxy group in the polyacid and results in formation of amide groups in the copolymer component.

The catalyst compound is optionally in combination with a tertiary amine compound or other relevant catalysts such as Sn (IV), Sn (II), Ti (IV), Zr (IV), Zn (II), Bi(II) metal catalysts; potassium salts such as potassium octoate, potassium hydroxide and potassium acetate; quaternary ammonium salts, and other catalysts used in relevant urethane chemistry. Various standard urethane reactions are compatible with such an amide reaction, including a polyol/polyisocyanate reaction, a water/isocyanate reaction, an amine/isocyanate reaction, an isocyanurate reaction, and the like. Additional catalysts may be present for desired reactions other than the amide/acid reaction, in producing the polymer having amide groups in combination with other monomeric groups in the backbone of the resulting copolymer.

Another embodiment of the invention is directed to a polymer foam material formed from a foamable composition comprising the following, the total amount of which is 100 weight percent (wt. %): 20 to 60 wt. % of an organic polyisocyanate component; 5 to 70 wt. % of a polyacid component substantially reactive with the polyisocyanate to form an amide group in a polyamide-urethane copolymer; 10 to 33 wt. % of a polyol component substantially reactive with the polyisocyanate component to form a urethane group in a polyamide-urethane copolymer; a surfactant composition component; and 0.5 to 5 wt. % of a catalyst system composition having substantial catalytic activity in the curing of said foamable composition, wherein the catalyst system composition comprises a catalyst compound comprising a cation of a metal, in a salt or ligand, which metal is selected from the group consisting of magnesium, cobalt, manganese, yttrium, Lanthanide Series metals, and combinations thereof, wherein the curing reaction is associated with the elimination of carbon dioxide derived from a carboxy group in the polyacid and results in formation of amide groups in the copolymer; wherein a second different catalyst compound is optionally also present for promoting the urethane reaction. The product can exhibit, as determined by TGA, a main onset of degradation that does not before 350° C.

In another embodiment, a rigid polymer foam material is formed from a foamable composition comprising an organic polyisocyanate component; a polyacid component substantially reactive with the polyisocyanate to form an amide group in a polyamide-urethane copolymer having urea groups; a polyol component substantially reactive with the polyisocyanate component to form a urethane group in a polyamide-urethane copolymer; at least 1% water; and a surfactant composition component; and a catalyst system composition having substantial catalytic activity in the curing of said foamable composition, wherein the catalyst system composition comprises a catalyst compound having a cation of a metal, in a salt or ligand, which metal is selected from the group consisting of magnesium, cobalt, manganese, yttrium, and Lanthanide Series metals, wherein the curing reaction is associated with the elimination of carbon dioxide derived from a carboxy group in the polyacid, resulting in formation of amide groups in the copolymer, and with the elimination of carbon dioxide derived from an isocyanate group in the organic polyisocyanate component, resulting in the formation of urea groups in the copolymer.

Yet another aspect of the present invention is directed to a method for forming the above-described thermally stable polymer foam materials. In one embodiment, a method of forming a tough thermally stable polymer foam comprises reacting an organic polyisocyanate component with a mixture comprising: a polyol component substantially reactive with the organic polyisocyanate component to form urethane groups in a resulting polyamide-urethane copolymer; a polyacid component substantially reactive with the organic polyisocyanate component to form an amide group in the polyamide-urethane copolymer; a surfactant component; and a catalyst system composition for curing the copolymer, comprising a catalyst compound having a cation of a metal, in a salt or ligand, which metal is selected from the group consisting of magnesium, cobalt, yttrium, manganese, Lanthanide Series metals, and combinations thereof, wherein the curing reaction is associated with the elimination of carbon dioxide derived from a carboxy group in the polyacid and results in formation of amide groups in the copolymer; and wherein foaming occurs at a temperature not more than 100° C.

Also disclosed is a polymer foam material obtainable from the method. The above-described material can be advantageously used in thermal insulation or other applications where heat resistance is desired. Because of the foregoing numerous features and advantages, the materials described herein are especially suitable for use for automotive and electronic applications. The above discussed and other features and advantages will be appreciated and understood by those skilled in the art from the following detailed description.

The above described and other features are exemplified by the following figures and detailed description.

### BRIEF DESCRIPTION OF THE DRAWINGS

FIG. 1 shows a TGA (Thermal Gravimetric Analysis) of the polyamide-urethane prepared in Example 1 and, for comparison, a polymer prepared in Comparative Example 2 from a comparable composition in which the polyol is absent and a different catalyst employed.

FIG. 2 shows a TGA analysis of the polyamide-urethane prepared in Example 3.

### DETAILED DESCRIPTION

A polyamide-urethane foam can be produced by the reaction of a polyfunctional acid, a polyfunctional isocyanate, and a polyol, using a specified catalyst system to allow the reaction to go near room temperature, specifically not more than 100° C. The catalyst system comprises a compound that is a salt or coordination complex of a cation of a metal, which metal is selected from the group consisting of magnesium, cobalt, manganese, yttrium, Lanthanide-series metals, and combinations thereof. For example, magnesium dimerate can be employed as catalyst. The catalyst compound is optionally in combination with a catalytic synergist such as a tertiary amine or other Lewis base, further in combination with another catalyst for complete gelation or curing of the foamable composition.

The reactions involved are complex towards obtaining the resulting polymer plus carbon dioxide (CO₂). The reaction product comprises a polymer that can be variously referred to as a modified polyamide copolymer, a polyamide-urethane, a polyamide-polyurethane, a polyamide-urethane-urea, a polyamide-polyisocyanurate, or a polyamide-urethane-urea-isocyanurate, meaning that the indicated groups, specifically the amide groups, urethane groups, etc. are present in the copolymer, specifically in the backbone of the polymer. For example, in one embodiment, urea groups are present in a polyamide-urethane-urea copolymer.

The further presence of a Lewis base or other co-catalyst or catalyst synergist can improve the catalytic effect. There is a synergistic effect, for example, between the polyamide catalyst compound and a tertiary amine, for example, bisdimethylaminoethyl ether, triethylenediamine, and the like. Both aliphatic and aromatic isocyanates can be reacted rapidly using, for example, a catalyst combination of magnesium dimerate and bisdimethylaminoethyl ether. In one embodiment, the further addition of a tin catalyst can further contribute to the curing of the system, specifically a urethane reaction.

In the present invention, the foaming and gelling are all part of the same reaction, unlike urethane chemistry, where foaming (a water/isocyanate reaction) and gelling reactions (polyol/isocyanate) involve different reactions. The curing reaction includes the following representative polyamide reaction.

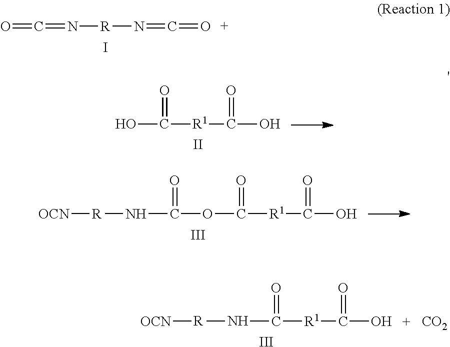

The R and R¹ are the organic groups originally present, respectively, in the reactants, i.e., the polyacid (II) and the polyisocyanate I (or isocyanate-terminated prepolymer (I) produced from the reaction of the original polyisocyanate and polyol components). The R and R¹ groups are, thus, consequently present in the intermediate mixed anhydride (III), which is semi-stable, leading to the amide compound (IV), which on further similar reaction will produce a polyamide having urethane groups.

In one embodiment, in which a polyol is present, the curing reaction simultaneously can include the following representative urethane reaction.

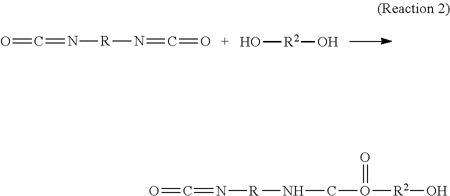

where R² is an organic group present in a polyols used in the urethane industry, such as polyether, polyester, and the like and mixtures thereof.

In still another embodiment, in which water is present, the curing agent can simultaneously include the following representative polyurea reaction.

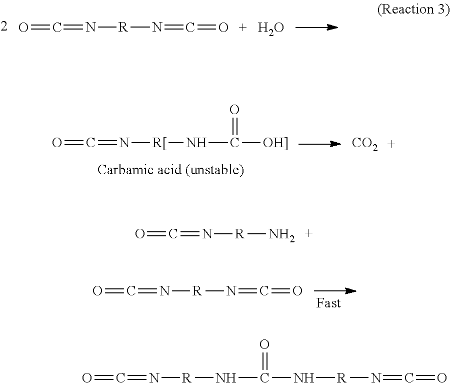

The reactants can be added successively or the polyurethane-polyamide can be made in a one-shot (one-step) reaction, involving the simultaneous mixture and subsequent reaction of all components.

According to the relevant literature, the reactions are complex and potentially undesirable side reactions can occur. According to Onder [K. Onder, Reaction Polymers, ed. W. F. Gunn, W. Riese, and H. Urich, page 406, Hanser publishers, 1992], the mixed anhydride intermediate III can react with more acid to form an anhydride and carbamic acid intermediate (which is unstable) and splits off CO₂ to form an amine, which in turn would react with isocyanate to form a substituted urea. These side reactions can be represented as follows:

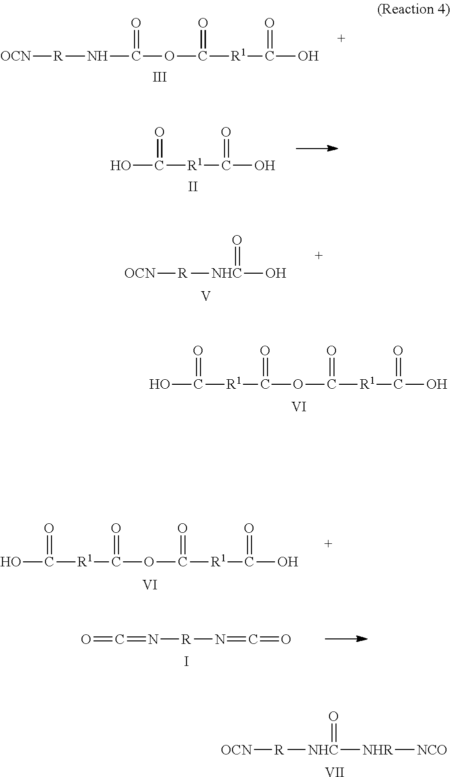

R and R¹ are as described above; compounds I to IV are the same as above. Compound V is the carbamic acid and Compound VI is a second anhydride intermediate. Compound VII is a substituted urea that is formed with the elimination of CO₂ from the second anhydride intermediate. According to Chen [Chen, Reaction Polymers, ed. W. F. Gunn, W. Riese, and H. Urich, page 406, Hanser publishers, 1992], the substituted urea VII and the anhydride VI can combine at extrusion temperatures to reform the mixed anhydride III and eventually form the polyamide.

In particular, the process of making the polyamide-urethane foam can comprise the polyol component, in the presence of the catalyst system, reacting out the active hydrogens on the polyol, in effect making the isocyanate-terminated prepolymer. Without wishing to be bound by theory, it is believed that the reaction of active hydrogens may precede, or may even require completion before, the amide reaction.

With the proper metal catalysis, the polyisocyanate reacts initially with the polyacid, having carboxylic acid groups, to form the mixed anhydride intermediate (III) above. This intermediate, however, can have some stability at room temperature and does not split off the carbon dioxide quantitatively at room temperature without some help. The present catalyst has been found to be surprisingly effective. Inadequate catalysis at low temperature can result in incomplete reaction, so that after the foam has risen and set, heating at a higher temperature can produce more CO₂ and split the foam apart.

In the present invention, using the required reaction components, the carbon dioxide formation is sufficient to produce polymer foam as desired, eliminating the need to add external blowing agents. When foam of lower density is desired, however, external blowing agents can be additionally used.

In forming a polyamide-urethane foam, the reaction can be carried out in the absence of foam-producing water. In particular, in one embodiment the reaction mixture for forming a polyamide-urethane contains essentially no water.

In another embodiment, water is added to the reaction mixture in order to produce lower density foam than produced by the amide/acid/urethane reactions alone. In such an embodiment, amide/urethane/substituted urea reactions occur, i.e. the resulting polymer comprises amide, urethane, and substituted urea groups. The urea reaction can be represented by the reaction 3 shown above.

In one embodiment, the amount of water in the composition is 0 to 7 weight percent based on the total foamable composition. The water can react with the isocyanate to produce foaming additional to that produced by the polyamide reaction. The use of both acid and water to produced foaming can be used to produce a lower density foam or rigid insulation.

The individual components used according to the present invention will now be more particularly described.

In general, the foam can be formed from reactive compositions comprising an organic isocyanate component reactive with the polyol component (an active hydrogen-containing component) polyacid, surfactant, and catalyst. The polyisocyanate component can be an aromatic, aliphatic, or arylaliphatic isocyanate. An organic isocyanate component generally comprises polyisocyanates having the general formula Q(NCO)ᵢ, wherein “i” is an integer having an average value of greater than two, and Q is an organic radical having a valence of “i”. Q can be a substituted or unsubstituted hydrocarbon group (e.g., an alkane or an aromatic group of the appropriate valency). Q can be a group having the formula Q¹-Z-Q¹ wherein Q¹ is an alkylene or arylene group and Z is —O—, —O-Q¹-S, —CO—, —S—, —S-Q¹-S—, —SO— or —SO₂—. Exemplary isocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, polymeric isocyanates such as polymethylene polyphenylisocyanate, and combinations comprising at least one of the foregoing isocyanates. Q in the above formula can also represent a polyurethane radical having a valence of “i”, in which case Q(NCO)ᵢ is a composition known as a prepolymer. Such prepolymers are formed by reacting a stoichiometric excess of a polyisocyanate as set forth hereinbefore and hereinafter with an active hydrogen-containing component as set forth hereinafter, especially the polyhydroxyl-containing materials or polyols described below.

The polyisocyanate is employed in stoichiometric excess with respect to the polyol component, the stoichiometry being based upon equivalents of isocyanate group per equivalent of hydroxyl in the polyol. The amount of polyisocyanate employed will vary slightly depending upon the nature of the specific polyamide urethane being prepared and the intended application.

In one embodiment, the polyisocyanate component has an isocyanate group functionality in the range from 1.8 to 5.0, more specifically in the range from 1.9 to 3.5 and most specifically in the range from 2.0 to 4.2. (For example, the aliphatic polyisocyanate trimer of hexamethylene diisocyanate (Desmodur® 3790BA) has a functionality of f=4.1)

Examples of suitable isocyanates are 1,5-naphthylene diisocyanate, xylylene diisocyanate (XDI), tetramethylxylylene diisocyanate (TMXDI), diphenyldimethylmethane diisocyanate derivatives, di- and tetraalkyldiphenylmethane diisocyanate, 4,4-dibenzyl diisocyanate, 1,3-phenylene diisocyanate, 1,4-phenylene diisocyanate, the isomers of tolylene diisocyanate (TDI), NDI (naphthalene diisocyanate), TODI (dimethyl-biphenylene diisocyanate), and PPDI (p-phenyl diisocyanate), optionally in admixture, 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4-diisocyanatophenyl-perfluorethane, tetramethoxybutane 1,4-diisocyanate, butane 1,4-diisocyanate, hexane 1,6-diisocyanate (HDI), dicyclohexylmethane diisocyanate, cyclohexane 1,4-diiso-cyanate, ethylene diisocyanate, bisisocyanatoethyl phthalate, also polyisocyanates with reactive halogen atoms, such as 1-chloromethylphenyl 2,4-diisocyanate, 1-bromo-methylphenyl 2,6-diisocyanate, 3,3-bischloromethyl ether 4,4-diphenyl diisocyanate.

4,4-Diphenylmethane diisocyanate (MDI), hydrogenated MDI (H12MDI) and polymeric methylene diphenyl diisocyanate are particularly suitable and the polymeric methylene diphenyl diisocyanate advantageously has a functionality of not less than 2.0.

The present foam composition involves the reaction of 20 to 70 wt. %, specifically 35-66 wt. % of at least one polyisocyanate component, preferably of 40-60 wt. % of at least one polyisocyanate component.

The polyisocyanate component can be contacted with the particular polyacid component, polyol component, catalyst, and surfactant together or in succession. The polyisocyanate component and polyol can react first to produce an isocyanate-functional prepolymer, which prepolymer in turn can have an lower isocyanate functionality for reaction with the polyacid.

Various polyols can be used to make the foam product, including both polymers and non-polymer compounds. Exemplary polyol polymers can include polyether polyol, aliphatic or aromatic polyester polyols, PIPA polyol, PHD polyol, SAN polymer (polymer polyols containing respectively polyurethane, polyurea or styrene-acrylonitrile particles), dendrimer polyols (for example, Boltorn® 500P), hydrogenated or unhydrogenated polybutadiene polyol, acrylic polyol, polythioether polyol, hydroxyl-terminated silicone polyol, polycarbonate polyol, copolymers of the foregoing, and combinations comprising at least one of the foregoing polyols. Specifically, the polyol component can comprise a polyoxyalkylene diol, a polyoxyalkylene triol, a polyoxyalkylene diol with polystyrene and/or polyacrylonitrile grafted onto the polymer chain, a polyoxyalkylene triol with polystyrene and/or polyacrylonitrile grafted onto the polymer chain, a polyester triol, or a combination comprising at least one of the foregoing polyols.

The polyol component can have a molecular weight of 150 to 10,000, specifically 200 to 8,000.

For making a rigid foam, sucrose-based polyol, mannitol-based polyether polyols, and or polyester polyol or combination thereof, are useful.

For making a resilient foam material, the polyol component can comprise a polyol triol having a molecular weight of 500 to over 6000, specifically, a polyester polyol having 2, 3, 4, or 5 hydroxy groups on average and a number average molecular weight of 500 to 6000.

The polyol component can include a mixture of polyhydroxyl-containing compounds, such as hydroxyl-terminated polyhydrocarbons (U.S. Pat. No. 2,877,212); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, and 2,621,166); hydroxymethyl-terminated perfluoromethylenes (U.S. Pat. Nos. 2,911,390 and 2,902,473); polyalkylene ether glycols (U.S. Pat. No. 2,808,391; British Pat. No. 733,624); polyalkylene ether glycols (U.S. Pat. No. 2,808,391; British Pat. No. 733,624); polyalkylenearylene ether glycols (U.S. Pat. No. 2,808,391); and polyalkylene ether triols (U.S. Pat. No. 2,866,774).

One class of polyhydroxyl-containing materials are the polyether polyols obtained by the chemical addition of alkylene oxides, such as ethylene oxide, propylene oxide and mixtures thereof, to water or polyhydric organic compounds, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy) methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, novolac resins, and the like. The alkylene oxides employed in producing polyoxyalkylene polyols normally have from 2 to 4 carbon atoms. Specifically, propylene oxide and mixtures or propylene oxide with ethylene oxide can be used, especially when preparing a resilient polymer foam.

Specific polyol components are polyol mixtures comprising polyether polyols and polyester polyols. More specifically, polyether polyols can include polyoxyalkylene diols and triols, and polyoxyalkylene diols and triols with polystyrene and/or polyacrylonitrile grafted onto the polymer chain, and mixtures thereof.

A specific class of polyether polyols is represented generally by the following formula:

R²[(OCₙH₂ₙ)_{z}OH]ₐ

wherein R² is hydrogen or a polyvalent hydrocarbon radical; a is an integer (i.e., 1 or 2 to 6 to 8) equal to the valence of R², n in each occurrence is an integer from 2 to 4 inclusive (preferably 3) and z in each occurrence is an integer having a value of from 2 to about 200, specifically from 15 to about 100.

Still another type of polyol is a grafted polyether polyol, obtained by polymerizing ethylenically unsaturated monomers in a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride and other ethylenically unsaturated monomers as identified and described in the abovementioned U.S. patent. Suitable polyols include those listed and described hereinabove and in the U.S. patent. The polymer polyol compositions can contain from 1 to about 70 weight percent (wt. %), preferably about 5 to about 50 wt. %, and most preferably about 10 to about 40 wt. % monomer polymerized in the polyol. Such compositions are conveniently prepared by polymerizing the monomers in the selected polyol at a temperature of 40° C. to 150° C. in the presence of a free radical polymerization catalyst such as peroxides, persulfates, percarbonate, perborates and azo compounds.

The polyol component can also include polymers of aromatic esters, aliphatic esters and cyclic esters. Aromatic esters are typically an orthophthalate-diethylene glycol polyester polyol such as Stepanpol® PS 20-200A from Stepan Company. Aliphatic esters are typically made from diethylene glycol and adipic acid, such as Lexorez® 1100-220 from Inolex chemical company and Fomrez® 11-225 from Witco Corporation. The preparation of the cyclic ester polymers from at least one cyclic ester monomer is well documented in the patent literature as exemplified by U.S. Pat. Nos. 3,021,309 through 3,021,317; 3,169,945; and 2,962,524. Suitable cyclic ester monomers include but are not limited to delta-valerolactone; epsilon-caprolactone; zeta-enantholactone; the monoalkyl-valerolactones, e.g., the monomethyl-, monoethyl-, and monohexyl-valerolactones.

Polyester polyols based on caprolactone can be formulated to obtain desired moduli, especially for a rigid foam polymer material.

Cyclic ester/alkylene oxide copolymers can also be prepared by reacting a mixture comprising cyclic ester and alkylene oxide monomers, an interfacial agent such as a solid, relatively high molecular weight poly(vinylstearate) or lauryl methacrylate/vinyl chloride copolymer (reduced viscosity in cyclohexanone at 30° C. from about 0.3 to about 1.0), in the presence of an inert normally-liquid saturated aliphatic hydrocarbon vehicle such as heptane and phosphorus pentafluoride as the catalyst therefor, at an elevated temperature, e.g., about 80° C.

Chain extenders and crosslinking agents can further be included. Exemplary chain extenders and cross-linking agents are low molecular weight diols, such as alkane diols and dialkylene glycols, and/or polyhydric alcohols, preferably triols and tetrols, having a molecular weight from about 80 to 450. The chain extenders and cross-linking agents are used in amounts from 0.5 to about 20 percent by weight, preferably from 10 to 15 percent by weight, based on the total weight of the polyol component.

In one embodiment of resilient polymer foam, the polyol component comprises one or a mixture of an ethylene oxide capped polyether oxide diol having a molecular weight in the range from about 2000 to about 10000; one or a mixture of a polyether oxide diol having a molecular weight in the range from about 1000 to about 6000.

In one embodiment of rigid polymer foam, the polyol component comprises a polyester polyol or triol. Specifically, the polyol component can comprise a polyester polyol, more specifically a polyester polyol having on average 3, 4, or 5 hydroxy groups, specifically a polyester triol, and a number average molecular weight of 750 to 2500, for example, a caprolactone triol having a molecular weight of 500 to 2000. Specifically, the polyol component can comprise a polyester polyol having a number average molecular weight in a range from 500 g/mol to 5000 g/mol, especially in the range from 600 g/mol to 2000 g/mol and more specifically in the range from 700 g/mol to 1500 g/mol.

Polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Exemplary dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as phthalic, isophthalic and terephthalic acids; tribasic or higher functional polycarboxylic acids such as pyromellitic acid; as well as anhydrides and second alkyl esters, such as maleic anhydride, phthalic anhydride and dimethyl terephthalate.

Additional polyol components are the polymers of cyclic esters. The preparation of cyclic ester polymers from at least one cyclic ester monomer is well documented in the patent literature as exemplified by U.S. Pat. Nos. 3,021,309 through 3,021,317; 3,169,945; and 2,962,524. Exemplary cyclic ester monomers include δ-valerolactone; ε-caprolactone; zeta-enantholactone; and the monoalkyl-valerolactones (e.g., the monomethyl-, monoethyl-, and monohexyl-valerolactones). In general the polyester polyol can comprise caprolactone based polyester polyols, aromatic polyester polyols, ethylene glycol adipate based polyols, and combinations comprising at least one of the foregoing polyester polyols, and especially polyester polyols made from ε-caprolactones, adipic acid, phthalic anhydride, terephthalic acid and/or dimethyl esters of terephthalic acid.

The polyols can have hydroxyl numbers that vary over a wide range. In general, the hydroxyl numbers of the polyols, including other cross-linking additives, if used, can be about 28 to about 1,000, and higher, or, more specifically, about 100 to about 800. The hydroxyl number is defined as the number of milligrams of potassium hydroxide required for the complete neutralization of the hydrolysis product of the fully acetylated derivative prepared from 1 gram of polyol or mixtures of polyols with or without other cross-linking additives. The hydroxyl number can also be defined by the equation:

$$OH = \frac{56.1 \times 1000 \times f}{{M}_{w}}$$

wherein: OH is the hydroxyl number of the polyol,
f is the average functionality, that is the average number of hydroxyl groups per molecule of polyol, and
Mw is the Equivalent Wt. of Polyol=56.1×1000/OH Number (See R. Herrington and K. Hock, Flexible Polyurethane Foams, 1991, Dow Chemical Co, p. 2.14)

In one embodiment, the polyisocyanate and polyol components can be used in a molar ratio of isocyanate groups to isocyanate-reactive groups, such as hydroxyl or carboxylic acid groups in the range of 10:1 to 1:2, more specifically from 5:1 to 1:1.5 and especially from 3:1 to 1:1.

The reaction mixture further comprises at least one polycarboxylic acid component, specifically dicarboxylic acid component (dimer), which can comprise an organic compound having at least or exactly two carboxyl groups, —COOH. The carboxyl groups can be bonded to alkyl or cycloalkyl moieties or to aromatic moieties. Aliphatic, aromatic, araliphatic or alkyl-aromatic polycarboxylic acids can be employed.

In the present context, “carboxylic acids” are understood to be acids which often contains one or more carboxyl groups (—COOH) but may also contain other active hydrogen groups including, but not limited to, hydroxyl, amine and mercapto functional groups.

The carboxyl groups may be connected to saturated, unsaturated and/or branched alkyl or cycloalkyl radicals or to aromatic radicals. They may contain other groups, such as ether, ester, halogen, amide, amino, hydroxy and urea groups. However, preferred carboxylic acids are those which may readily be processed as liquids at room temperature, such as native fatty acids or fatty acid mixtures, COOH-terminated polyesters, polyethers or polyamides, dimer fatty acids and trimer fatty acids. The following are specific examples of the carboxylic acids according to the invention: acetic acid, valeric acid, caproic acid, caprylic acid, capric acid, lauric acid, myristic acid, palmitic acid, stearic acid, isostearic acid, isopalmitic acid, arachic acid, behenic acid, cerotic acid and melissic acid and the monounsaturated or polyunsaturated acids palmitoleic, oleic, elaidic, petroselic, erucic, linoleic, linolenic and gadoleic acid. The following carboxylic acids are also mentioned: adipic acid, sebacic acid, isophthalic acid, terephthalic acid, trimellitic acid, phthalic acid, hexahydrophthalic acid, tetrachlorophthalic acid, oxalic acid, muconic acid, succinic acid, fumaric acid, ricinoleic acid, 12-hydroxystearic acid, citric acid, tartaric acid, di- or trimerized unsaturated fatty acids, optionally in admixture with monomeric unsaturated fatty acids and, optionally, partial esters of these compounds. It is also possible to use complex esters of polycarboxylic acids or carboxylic acid mixtures containing both COOH and OH groups. Examples of these are citric acid, malic acid, and lactic acid. In one embodiment, the polyacid component does not contain any hydroxyl groups in addition to the carboxyl groups and free acid groups. In another embodiment, a polyacid such as citric acid contains three carboxylic acid groups and one hydroxyl group, which polyacid can be used in the process. In one embodiment, the polycarboxylic acid used to make the present polymer foam is a dimer or trimer fatty acid. This is understood to be a mixture of predominantly C₃₆ dicarboxylic acids which is prepared by thermal or catalytic dimerization of unsaturated C₁₈ monocarboxylic acids, such as oleic acid, tall oil fatty acid or linoleic acid. The dimerization actually yields a mixture of mono-di- and tri-carboxylic acids, and the monocarboxylic acids are distilled from the polyfunctional acids resulting in crude dimer fatty acids, which can be further purified into pure dimer and trimer by distillation. The dimer or trimer fatty acid can be unhydrogenated or hydrogenated for oxidation stability. Hydrogenation produces a more oxidatively stable product, because there is a vinyl group in the dimer acid that is prone to oxidation, which vinyl group can be reacted out at slightly higher cost.

Dimer and trimer fatty acids are well-known among experts and are commercially obtainable. They are commercially available from, for example, Uniquema (Wilmington, Del.) under the trademark Pripol® dimer fatty acids. Pripol® 1006 and 1009 are hydrogenated dimer acid.

In another embodiment, the dimer acid can be selected from smaller molecules, for example, C3-C6 compounds, specifically glutaric aid. Polyacid oligomers can also be used. Any oligomer with at least one acid functionality and other isocyanate reactive moieties like hydroxyls, amines, mercaptans, etc can be useful in building polyamide urethanes. Commercially available polyacid oligomers include, for example, Priplast® 2104, a polyester diacid from Croda, and CTBN, CTB, and CTBNX from Hypro. CTBN is carboxyl-terminated butadiene nitrile.

Polyacid oligomers can be made by adding a diacid in stoichiometric excess with a polyol, heating and esterifying and at the same time removing water by a Dean Stark trap to drive the equilibrium toward ester formation.

An aromatic polyacid can be formed by the addition of terephthalic acid, isophthalic acid, ortho-phthalic acid, or other di-acids or polyfunctional acids to PET (polyethylene terephthalate) and hydrolyzing the polymer back to oligomeric status to produce an aromatic ester with carboxylic acid functionality instead of hydroxyl.

In the same manner, aliphatic and aromatic polyesters/copolymers can be made by adding aliphatic diacids in excess such as adipic, glutaric, terephthalic, or the like acids to diols such as ethylene glycol, 1,4-butanediol, 1,3-propanediol, hexamethylene diol, or the like, and esterifying or partially esterifying as in the case of Kluth et al., U.S. Pat. No. 5,527,876 to Kluth et al, thereby producing aliphatic or mixed aryliphatic acid-terminated polyesters.

The starting materials and catalysts mentioned above can be used in the following quantitative ratios: for every equivalent of isocyanate, there are 0.1 to 5 and preferably 0.1 to 2 equivalents of a mixture of polyacid and polyol, the ratio of alcohol to acid being from 20:1 to 1:20.

In another embodiment for making a foam material that can replace current rigid polyurethane foams, an additional reaction can include, for example, a water/isocyanate reaction or an isocyanurate reaction in which a corresponding catalyst is used to catalyze that reaction as well as optional external blowing agents. Common catalysts that work in such rigid foams can include, but are not limited to, bisdimethylaminoethylether, triethylenediamine, N,N,N′N″,N″-pentamethyl dipropylenetriamine, N, N-cyclohexylamine, or the like, and acid-blocked derivatives thereof.

Thus, in this embodiment, a plurality of basic reactions can be used to make the foams, including a gelation reaction involving the polyurethane reaction between polyols and polyisocyanates which would form a flexible or rigid elastomer, the water/isocyanate reaction which produces carbon dioxide to form the foam cells, as well as the acid/isocyanate amide-producing reaction producing further carbon dioxide. In rigid foams external blowing agents, such as pentanes, HCFCs and the most recent addition HFOs (hydrofluoro-olefins) can also be utilized to some extent.

It is advantageous to include the acid/isocyanate amide-producing reaction at least in part, i.e. to replace the water/isocyanate reaction at least in part, because it can be lower in cost. It takes two equivalents of isocyanate to produce one equivalent of CO₂, whereas this new reaction replaces one isocyanate equivalent with a lower cost dimer acid. By so doing, not only is its manufacture lower in cost, it can also be a matter of replacing a material that is based on non-renewable petroleum with one made from renewable raw materials. Dimer acid can include dimerized oleic acid, wherein the main source of a pure oleic acid is tall oil obtainable from pine trees.

A wide variety of surfactants can be used for purposes of stabilizing the polyamide urethane foam before it is cured, including mixtures of surfactants. Organosilicone surfactants are especially useful for both rigid and flexible materials. Silicone surfactants can include, but are not limited to the following, For example, the organosilicone surfactant can include copolymers consisting essentially of SiO₂ (silicate) units and (CH₃)₃SiO_{0.5} (trimethylsiloxy) units in a molar ratio of silicate to trimethylsiloxy units of about 0.8:1 to about 2.2:1, or, more specifically, about 1:1 to about 2.0:1. Another organosilicone surfactant stabilizer is a partially cross-linked siloxane-polyoxyalkylene block copolymer and mixtures thereof wherein the siloxane blocks and polyoxyalkylene blocks are linked by silicon to carbon, or by silicon to oxygen to carbon, linkages. The siloxane blocks can comprise hydrocarbon-siloxane groups and have an average of at least two valences of silicon per block combined in the linkages. Some portion of the polyoxyalkylene blocks can comprise oxyalkylene groups and are polyvalent, i.e., have at least two valences of carbon and/or carbon-bonded oxygen per block combined in said linkages. Any remaining polyoxyalkylene blocks comprise oxyalkylene groups and are monovalent, i.e., have only one valence of carbon or carbon-bonded oxygen per block combined in said linkages. Additional organopolysiloxane-polyoxyalkylene block copolymers include those described in U.S. Pat. Nos. 2,834,748, 2,846,458, 2,868,824, 2,917,480 and 3,057,901. Combinations comprising at least one of the foregoing surfactants can also be employed. The amount of the organosilicone polymer used as a foam stabilizer can vary over wide limits, e.g., about 0.5 wt. % to about 10 wt. % or more, based on the amount of the active hydrogen component, or, more specifically, about 1.0 wt. % to about 6.0 wt. %.

As mentioned above, the catalyst used to prepare the present foam materials, includes a catalyst system that comprises a catalyst compound for promoting the polyamide reaction, which catalyst compound has a cation of a metal in salt or ligand form, which metal is selected from the group consisting of magnesium, cobalt, manganese, yttrium, or Lanthanide Series metals. This catalyst compound is associated with the elimination of carbon dioxide derived from a carboxy group in the polyacid and results in formation of amide groups in the copolymer that forms the foam material.

In one embodiment, the catalyst compound comprises a magnesium cation, for example, selected form the group consisting of magnesium hydroxide, magnesium oxide, magnesium acetate, magnesium stearate, and magnesium dimerate. In another embodiment, the catalyst comprises a cobalt cation, for example, cobalt (II) naphthenate. In yet another embodiment, the catalyst comprises a Lanthanide-Series metal. Lanthanide series compounds (salts or ligands) can include, for example, lanthanum (III) chloride hexahydrate, neodymium (III) chloride hexahydrate. An example of an yittrium-containing catalyst is yittrium (III) chloride hexahydrate.

Specifically, the catalyst compound can comprise a magnesium salt or coordination complex (for example, a magnesium dimerate). The presence, in the magnesium-containing catalyst of Mg⁺² is believed necessary for achieving the desired relatively low temperature reaction, whereas the ligand or counter ion in combination with the metal can vary without undue effect. In one embodiment, a magnesium dimerate catalyst can be made by adding magnesium acetylacetonate to dimer acid and then boiling off the acetyl acetone. In another embodiment, a magnesium-containing catalyst can be made by reacting magnesium acetylacetonate or other magnesium ligand with an aromatic polyester polyol such as Terate® 5503 polyol to obtain magnesium in reaction-product association with an aromatic polyester polyol.

A magnesium dimerate catalyst compound can be synthesized, for example, by adding 10 grams anhydrous magnesium (II) acetylacetonate (Mg (acac)) to 10 grams to 90 grams of a hydrogenated dimer acid, such as Pripol® 1006 polyol in a round bottom flask equipped with vacuum, heating and glass rod stirring assembly. When the mixture is heated to 150° C. under vacuum with stirring, the Mg (acac) melts and reacts into the dimer acid with the acac coming off. After heating for 5 hrs under vacuum, the heat is turned off, cooled and transferred to a glass bottle to be used as a catalyst solution. The amount of catalyst present in the reactive composition can be about 0.05 wt. % to about 6.0 wt. %, specifically 1 to 5 wt. %, based on the required reactants, including isocyanate, polyacid, polyol, surfactant and catalyst.

The catalyst compound can be present, in an effective amount, in association with a second catalyst compound for the urethane reaction. Specifically, the second catalyst compound can comprising another metal cation for promoting a urethane reaction. For example, a tin catalyst and/or a tertiary amine such as triethylene diamine can be used for the urethane curing reaction

In one embodiment, the composition for forming the polymer foam further comprises a catalyst for converting the polyisocyanate to isocyanuric acid (1,3,5-triazine-2,4,5*1H,3H,5H)-trione). For example, a catalyst compound for converting the polyisocyanate to isocyanuric acid is an alkali metal such as potassium catalyst.

The catalyst compound, or the catalyst system composition can be present in an amount of 0.5 to 5 weight percent of the solid reaction product.

The catalyst compound according to the invention can be optionally combined with a catalytic synergist. Amines that catalyze the urethane reaction may also be synergistic with the polyamide catalyst compound. The addition of water can also increase the speed of the curing.

A catalytic synergist can be characterized in that they are highly nucleophilic by virtue of their ability to stabilize positive charges. This property is present to a significant extent in aliphatic tertiary amines, particularly those of cyclic structure. Among the tertiary amines, those additionally containing isocyanate-reactive groups, more particularly hydroxyl and/or amino groups, are also suitable. The following are specifically mentioned: dimethyl monoethanolamine, diethyl monoethanolamine, methyl ethyl monoethanolamine, triethanolamine, trimethanolamine, tripropanolamine, tributanolamine, trihexanolamine, tripentanolamine, tricyclohexanolamine, diethanol methyl amine, diethanol ethyl amine, diethanol propyl amine, diethanol butyl amine, diethanol pentylamine, diethanol hexyl amine, diethanol cyclohexyl amine, diethanol phenyl amine and ethoxylation and propoxylation products thereof, diazabicyclooctane (Dabco), triethyl amine, dimethyl benzyl amine (Desmorapid DB, Bayer AG), bis-dimethylaminoethyl ether (Catalyst A I, UCC), tetramethyl guanidine, bis-dimethylaminomethyl phenol, 2,2′-dimorpholinodiethyl ether, 2-(2-dimethylaminoethoxy)-ethanol, 2-dimethylaminoethyl-3-dimethylaminopropyl ether, bis-(2-dimethylaminoethyl)-ether, N,N-dimethyl piperazine, N-(2-hydroxyethoxyethyl)-2-azanorbornanes, Texacat DP-914 (Texaco Chemical), N,N,N,N-tetramethyl butane-1,3-diamine, N,N,N,N-tetramethyl propane-1,3-diamine, N,N,N,N-tetramethyl hexane-1,6-diamine.

Heteroaromatic amines can also be used, particularly when they contain at least one nitrogen atom in the ring and other heteroatoms or functional groups which have a positive inductive and/or positive mesomeric effect. Examples of such catalysts are derivatives of pyrrole, indolizine, indole, isoindole, benzotriazole, carbazole, pyrazole, imidazole, oxazole, isooxazole, isothiazole, triazole, tetrazole, thiazoles, pyridine, quinoline, isoquinoline, acridine, phenanthridine, pyridazines, pyrimidines, pyrazine, triazines and compounds containing corresponding structural elements. The catalysts may also be present in oligomerized or polymerized form, for example as N-methylated polyethylene imine. Specific catalysts are amino-substituted pyridines and/or N-substituted imidazoles.

Optional additives can be added to the reactive composition in the manufacturing process. For example, additives such as a wide variety of fillers (for example, not limited to alumina trihydrate, aluminum hydroxide, silica, talc, calcium carbonate, clay, and so forth), dyes, pigments (for example titanium dioxide and iron oxide), antioxidants, antiozonants, flame retardants, UV stabilizers, conductive fillers, conductive polymers, and so forth, as well as combinations comprising at least one of the foregoing additives, can also be used. Other optional additives include reinforcing fillers such as woven webs, silica, glass particles, and glass microballoons. Fillers can be used to provide thermal management or flame retardance.

External blowing agents are optional, especially for rigid foam materials. External blow agents such as methyl formate, pentanes, cyclopentane, HCFCs, HFO (hydrofluoro-olefins), and the like, can be used to lower the density of the foam product, as may be desired for certain applications.

As mentioned earlier, the foam product can be made by reacting an organic polyisocyanate component with a mixture comprising a polyol component substantially reactive with the organic polyisocyanate component to form urethane groups in a resulting polyamide-urethane copolymer, a polyacid component substantially reactive with the organic polyisocyanate component to form an amide group in the polyamide-urethane copolymer; a surfactant component; and a catalyst system composition as described herein. The curing reaction is associated with the elimination of carbon dioxide derived from a carboxy group in the polyacid and results in formation of amide groups in the copolymer; and foaming occurs at a temperature not more than 100° C.

This reaction can proceed quite well at room temperature, but the foam appears to be stronger and more completely reacted if the raw materials are heated to not more than 100° C. In fact, undesirable side reactions may be more prevalent at higher temperatures. The indicated temperature range can be advantageous, because most urethane polymerizations are commercially carried out at or below 100° C. and it may be desirable to use the same processing equipment, with limited modification, for carrying out the present process.

In the manufacture of the foam material, foam parameters include “cream time,” “rise time,” “gel time,” and “tack free time.”

Cream time is defined as follows. At time 0, the foam is mixed and doesn't appear to do anything for several seconds. In reality the foaming reaction is taking place, but the first amount of CO₂ coming off is soluble in the polyol/isocyanate mixture. When the cells start to nucleate (gas coming out of solution) the mixture can turn white (taking on the appearance of cream), thus the term, “cream time.” It is the first indication of how quickly the foaming reaction is going.

Rise time is defined as the time for the foam to reach most of its height (+90%). In one embodiment, a gel rise times under about 1.0 minute is obtained, similar to most commercial urethane processes.

Gel time, in contrast to the first two parameters used in monitoring the blowing reaction, is an indication of the advancing urethane reaction. For all foams flexible and rigid, you normally need the blowing reaction to complete at the same time or shortly after the blowing reaction. It is monitored by sticking a spatula into the foam at different time intervals. The gel time is when the spatula first pulls a gelled string out of the foam.

Tack free time is the time after both reactions are complete when the top of the foam is no longer tacky to the touch.

In one embodiment, the process for producing polymer foam can be carried out at a temperature in a range from at least 10° C. to at most 100° C., more specifically from at least preferably 15° C. to about 80° C., specifically at a temperature from at least 20° C. to about 65° C. and more specifically at a starting temperature from about 23° C. to about 55° C., most specifically at room temperature or within 10° C. or within 15° C. of room temperature. The temperature can apply to the entire curing reaction or the temperature at which the foaming is initiated and/or takes place. The temperature can rise in the course of the reaction. Typically, the reaction takes place in an oven, particular for a rigid polyurethane boardstock. The reaction can be accelerated by a tertiary amine compound, as discussed above, wherein the process provides complete and rapid further reaction between diisocyanate components and dicarboxylic acid components to form an amide group.

In one embodiment, the reaction temperature at which the elimination of CO₂ begins is at or below 100° C., specifically below 60 C, more specifically about 50° C. or below. In one embodiment, the reaction temperature is below 35° C. More particularly, even the molds do not have to be preheated. It is sufficient to mix the reactants at those temperatures or to bring the mixture to those temperatures by application of external heat. The reaction preferably begins at room temperature, i.e. at 20 degree. C.+/−15. It can be of advantage to heat the starting reaction mixture to 30° to 70° C., for example to reduce density and additionally to accelerate the reaction.

The reaction of the abovementioned components can take place at atmospheric pressure. The reaction time can be varied within wide limits, above all through the choice of the catalysts and their concentration, and can thus be adapted to the particular application. Without heating, the reaction time is less than 24 hours, preferably less than 2 hours and, more preferably, less than 0.5 hour starting from the mixing of the reactants to substantially complete curing. At room temperature (20 C+/−15° C.), however, reaction times of 3 to 90 seconds, specifically less than 15 seconds can even be sufficient.

In one embodiment, a rigid foam board can be allowed to cure for one day for every inch of thickness. Thus, for example, a two-inch thick board, would be held in a warehouse for two days before being shipped out.

In general, the reactants, i.e. the isocyanate, the carboxylic acid, the polyol and the catalyst composition can be simultaneously combined without having reacted with one another beforehand. However, individual components can also be mixed or allowed to react with one another beforehand, for example a mixture of carboxylic acid and alcohol or a mixture of carboxylic acid and isocyanate or a mixture of carboxylic acid and amine.

The mixture can then further processed, for example, in open molds or on belts to form a layer. However, the reaction mixture can also be applied to a substrate by spraying, casting or spreading to form a permanent layer. In one embodiment, the reactive mixture is deposited onto the first carrier. For convenience, this first carrier can be referred to as “bottom carrier,” and is generally a moving support that may or may not readily release the cured foam. A second carrier, also referred to herein as a “surface protective layer” or “top carrier” can optionally be placed on top of the froth. The optional top carrier is also a moving support that also may or may not readily release from the cured foam, provided that at least one carrier readily releases from the foam. The top carrier can be applied almost simultaneously with the froth. Before applying the top carrier, the foam can be spread to a layer of desired thickness, e.g., by a doctoring blade or other spreading device. Alternatively, placement of the top carrier can be used to spread the foam and adjust the foamed layer to the desired thickness. In still another embodiment, a coater can be used after placement of the top carrier to adjust the height of the foam.

In practice, the carriers can be played out from supply rolls and ultimately rewound on take-up rolls upon separation from the cured polyurethane foam. The selection of materials for the top and bottom carriers will depend on factors such as the desired degree of support and flexibility, the desired degree of releasability from the cured foam, cost, aesthetics, and so forth, considerations. Paper, thin sheets of metal such as stainless steel, or polymer films such as polyethylene terephthalate, silicone, or the like, can be used. The material can be coated with a release coating. In one embodiment, the carrier can be coated with a material intended to be transferred to the surface of the cured polyurethane foam, for example a substrate film that is releasable from the carrier. A fibrous web or other filler material can be disposed on the surface of the carrier, and thereby become ultimately incorporated into the cured foam. In another embodiment, the foam can cure to one or both of the carriers. Thus, one carrier can form part of the final product instead of being separated from the foam. Alternatively, or in addition, a conveyor belt can be used as the bottom carrier. The carriers can have a plain surface or a textured surface. In a particular embodiment, the surface of the foam is provided with a skin layer.

The polyamide urethane produced by the reaction mixture can have higher melting points or T_{g} and higher decomposition temperatures than pure polyurethanes.

The properties of the foams formed as described above (e.g., density, modulus, compression load deflection, tensile strength, tear strength, and so forth) can be adjusted by varying the components of the reactive compositions. In general, when used as a component of footwear, the foam can have a density of about 50 kg/m³ to about 500 kg/m³, specifically about 70 kg/m³ to about 400 kg/m³, more specifically about 100 kg/m³ to about 350 kg/m³, still more specifically about 200 kg/m³ to about 300 kg/m³.

The physical properties of such foams are excellent. For example, such foams can have a compression set resistance of less than or equal to about 10%, or, more specifically, less than or equal to about 5%.

In order to provide good mechanical properties to the foam, the average cellular diameter of the foam can be about 10 micrometers (m) to about 1 millimeter (mm), or, more specifically, about 50 micrometers to about 500 micrometers. In open-celled foams where at least a portion of the cells extend through the sheet, through holes can be distinguished from such open cells on the basis of size.

In one embodiment, rigid polymer foam can be produced. Rigid polymer foams having a higher proportion of amide bonds therefore likewise have a higher melting point and a higher decomposition temperature and hence are particularly suitable for high-temperature applications, for example as insulating material in the engine compartment of a motor vehicle. A polymer will start degrading at its weakest point. The polyamide is more thermally stable than a urethane, but if there are urethane linkages, there is always an onset of degradation seen in the TGA by the urethane linkage. From there the polyamide/urethane does degrade more slowly than a urethane but if there are urethane linkages, it will start ˜303° C.

In one embodiment, rigid polymer foam can be produced. Rigid polymer foams having a higher proportion of amide bonds therefore likewise have a higher melting point. A polyamide is more thermally stable than a urethane, but if there are urethane linkages, there is always an onset of degradation seen in the TGA by the urethane linkage. From there the polyamide-urethane does degrade more slowly than a urethane, but if there are urethane linkages, it can start at about 300° C. Thus, a polymer will generally start degrading at its weakest point.

Applications for the foam products disclosed herein include, for example, thermal insulation or engineering materials. For thermal insulation, the foam product can be used in refrigerating or freezing appliances, appliances for hot water preparation or storage or parts thereof, or for thermal insulation of buildings or vehicles. In the above applications, the rigid polymer foam can be in the form of a thermal insulating layer. The rigid polymer foam can also be used to form the entire housing or outer shells of appliances, buildings or vehicles. Other uses include dielectric spacers for antennae. For the purposes of the present invention, vehicles or “automotive” applications include air, land or water vehicles, especially airplanes, automobiles or ships. Due to its thermal stability, insulation according to the present invention can be used under the hood of vehicles. Resilient foam material can be used for cushioning, including cushions for seating or resting.

### EXAMPLES

### Example 1

This example illustrates polyamide-urethane foam produced in accordance with the present invention. The formulation in Table 1 was used.

TABLE 1

| | | | Amount |
|---|---|---|---|
| | | Commercial | (parts by |
| Component | Description | Source | weight) |
| Polyacid | PRIPOL 1009 dimer | Croda | 70 |
| | acid | | |
| Polyol | CAPA 3031 | Perstorp | 30 |
| | polycaprolactone triol | | |
| Surfactant | DC-1598 - surfactant | Dow Corning | 2 |
| Catalyst 1 | Mg Dimerate | Synthesized | 3 |
| Amine | UAX-1248 | Momentive | 0.5 |
| | Acid-Blocked Tertiary | | |
| | Amine | | |
| Catalyst 2 | FOMREZ UL-1 tin | Momentive | 0.1 |
| | catalyst | | |
| Polyisocyanate | PAPI 27 | Dow Chemical | 75.0 |

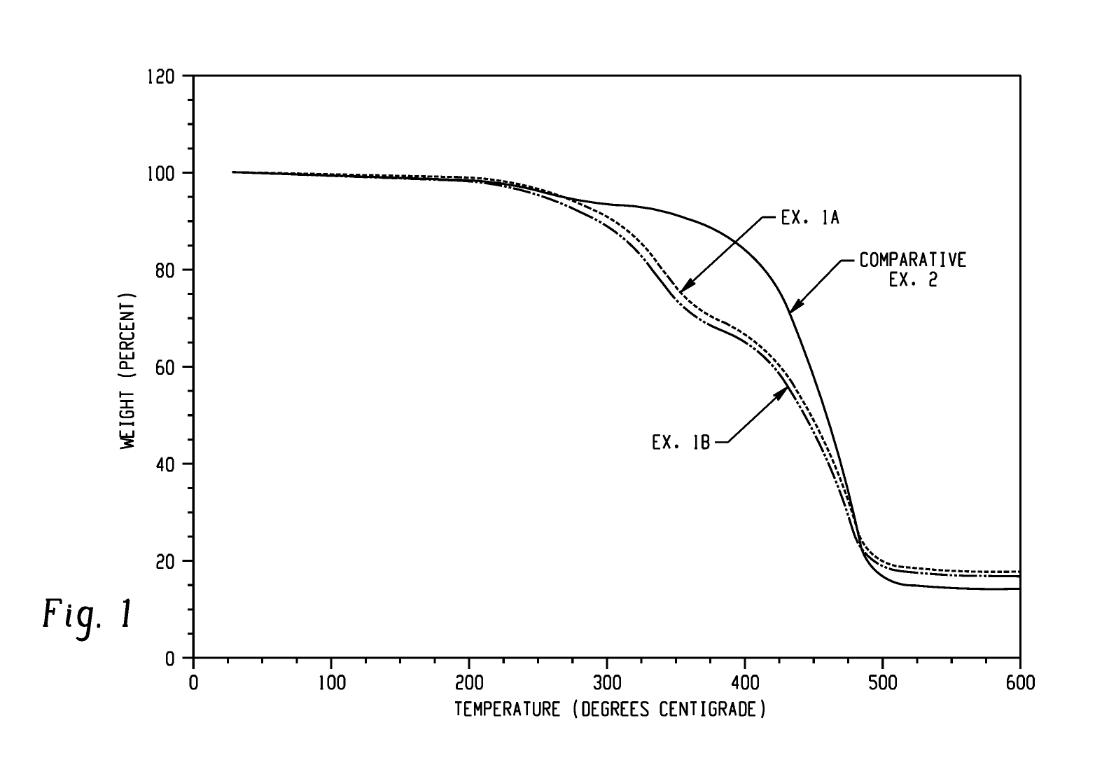

All raw materials except the polyisocyanate (PAPI) were first mixed together in a 1000-ml polypropylene beaker using an air mixer to stir. The raw materials were then put in the oven at 50° C. for ½ hr. The heated mixture was removed, re-stirred, the polyisocyanate (at room temperature) was added, and the composition stirred for 30 seconds. The foam was allowed to cure at room temperature. The foam produced was rigid, strong structural foam of about 3.5 pcf. The TGA of the polyamide-polyurethane is shown in FIG. 1, showing the results of two trials Example 1A and 1B. Example 1A was cured in the oven for 3 days at 112° C., whereas Example 1B was cured at room temperature.

It is noted that the T_{g} of the foam product is much higher than that of typical urethanes with a T_{g} of about 160° C. After the foam is cured for 3 days at 112° C., the T_{g} is even higher, approaching 200° C.

The product foam in this example exhibited a thermal stability as shown in FIG. 1, as determined by TGA.

### Comparative Example 2

This example illustrates a comparative foam product, i.e., pure polyamide in which no polyol component was employed and in which a cobalt catalyst was employed to prepare the foam reaction product. The formulation in the following Table 2 was used.

TABLE 2

| | | | Amount |
|---|---|---|---|
| | | | (parts by |
| Component | Description | Source | weight) |
| Polyacid | Pripol ® 1009 dimer | Croda | 100 |
| | acid | | |
| Surfactant | DC-1598 ® surfactant | Dow | 2 |
| | | Corning | |
| Catalyst 1 | 6% Co naphthanate | Shepherd | 1 |
| | | Chemical | |
| | | Co. | |
| Amine | UAX-1248 ® Acid- | Momentive | 1 |
| | Blocked Tertiary Amine | | |
| Polyisocyanate | PAPI 901 ® polymeric | Dow | 49.4 |
| | MIDI | Chemical | |

All raw materials except the polyisocyanate (PAPI 901) were blended together in a 1000-ml polypropylene beaker using an air mixer to stir. The PAPI 901 was then added and the materials mixed for 30 seconds. The foam was allowed to cure at room temperature. The “cream time” is the time from when the PAPI was first added to the time the foam started to rise. The “TOC” is the time needed for the foam to rise to the top of the cup. The “gel time” is the time needed for the polymer to gel, which is determined by sticking a wooden spatula into the foam and removing repeatedly until the spatula pulls a gelled string of polymer on the spatula upon removal.

The cream time was 1 minute, 50 seconds; the TOC time was 3 minutes, 23 seconds; and the gel time was 4 minutes, 40 seconds. The product foam of Example 2 was very weak and brittle.

The product foam in this comparative example had a thermal stability of a polyamide as determined by TGA (FIG. 1). The onset of degradation is anywhere from 270-303° C. The foam of Example 1, however, showed a comparative improvement in the onset of degradation compared to this Comparative Example 2. Instead of 270-303° C., the onset of degradation is closer to 425° C., an improvement by over 100° C.

### Examples 3-5

Example 3-5 show various polyamide-urethane foam materials produced in accordance with the present invention. The formulations in Table 3-5 were used.

TABLE 3

| Component | Description | Source | Amount |
|---|---|---|---|
| Polyacid | Unidyme ® 14 dimer | Arizona | 60 |
| | acid, low monomer and | Chemical | |
| | trimer content. | | |
| Polyol | Acclaim ® 4220 polyol | Bayer | 30 |
| | is a 4,000-molecular- | MaterialScience | |
| | weight diol based on | | |
| | propylene oxide and | | |
| | ethylene oxide. | | |
| Surfactant | DC-1598 ® surfactant | Dow Corning | 0.3 |
| Catalyst 1 | Mg Dimerate | Synthesized. | 3 |
| Surfactant | L-5617 ® silicone | Momentive | 2 |
| | stabilizer | | |
| Polyisocyanate | PAPI ® 901 | Dow Chemical | 32.03 |

TABLE 4

| | | | Amount |
|---|---|---|---|
| Component | Description | Source | (php) |
| Polyacid | Unidyme ® 60 dimer | Arizona | 18.5 |
| | acid | Chemical | |
| Polyol | Acclaim ® 6320N | Bayer | 73.97 |
| | 6,000-molecular-weight | MaterialScience | |
| | copolymer triol based | | |
| | on propylene oxide and | | |
| | ethylene oxide | | |
| Diol | 1,4-butanediol | CAS number • | 2.91 |
| | | 110-63-4 | |
| Surfactant | Niax L-5617 ® | Momentive | 2.78 |
| Catalyst 1 | Mg Dimerate (10%) | Synthesized. | 1.84 |
| Polyisocyanate | PAPI ® 901 | Dow Chemical | 23.47 |

TABLE 5

| Component | Description | Source | Amount |
|---|---|---|---|
| Polyacid | Unidyme ® 60 dimer | Arizona | 29.13 |
| | acid | Chemical | |
| Polyol | Acclaim ® 6320N | Bayer | 67.96 |
| | polyether alcohol | MaterialsScience | |
| Surfactant | NiaxL-5617 ® | Momentive | 3.0 |
| AO | Irganox ® 1135 | Ciba | 0.18 |
| | sterically hindered | | |
| | phenolic antioxidant | | |
| AO | Irganox ® 5057 | Ciba | 0.1 |
| | sterically hindered | | |
| | phenolic antioxidant | | |
| Catalyst 1 | Mg Dimerate (10%) | Synthesized | 2.43 |
| Polyisocyanate | Mondur ® MRS | Bayer | 19.81 |
| | medium functionality | MaterialScience | |
| | polymeric | | |
| | diphenylmethane | | |
| | diisocyanate with an | | |
| | enhanced 2,4′-MDI | | |
| | isomer content | | |

A foam product can be prepared from the above formulation as follows. All raw materials except the polyisocyanate (PAPI) are mixed together in a 1000-ml polypropylene beaker using an air mixer to stir. The raw materials are then put in the oven at 50° C. for ½ hr. The heated mixture is removed, re-stirred, the polyisocyanate (at room temperature) is added, and the composition is stirred for 30 seconds. The foam is allowed to cure at room temperature.

For Example 3, the cream time was 1 minute, 50 seconds; the TOC time was 3 minutes, 23 seconds; and the gel time was 4 minutes, 40 seconds.

The foam produced using the above formulation of Table 3 was tough, resilient foam having a thermal stability that was far better than expected. In contrast, the product foam of comparative Example 2 was very weak and brittle.

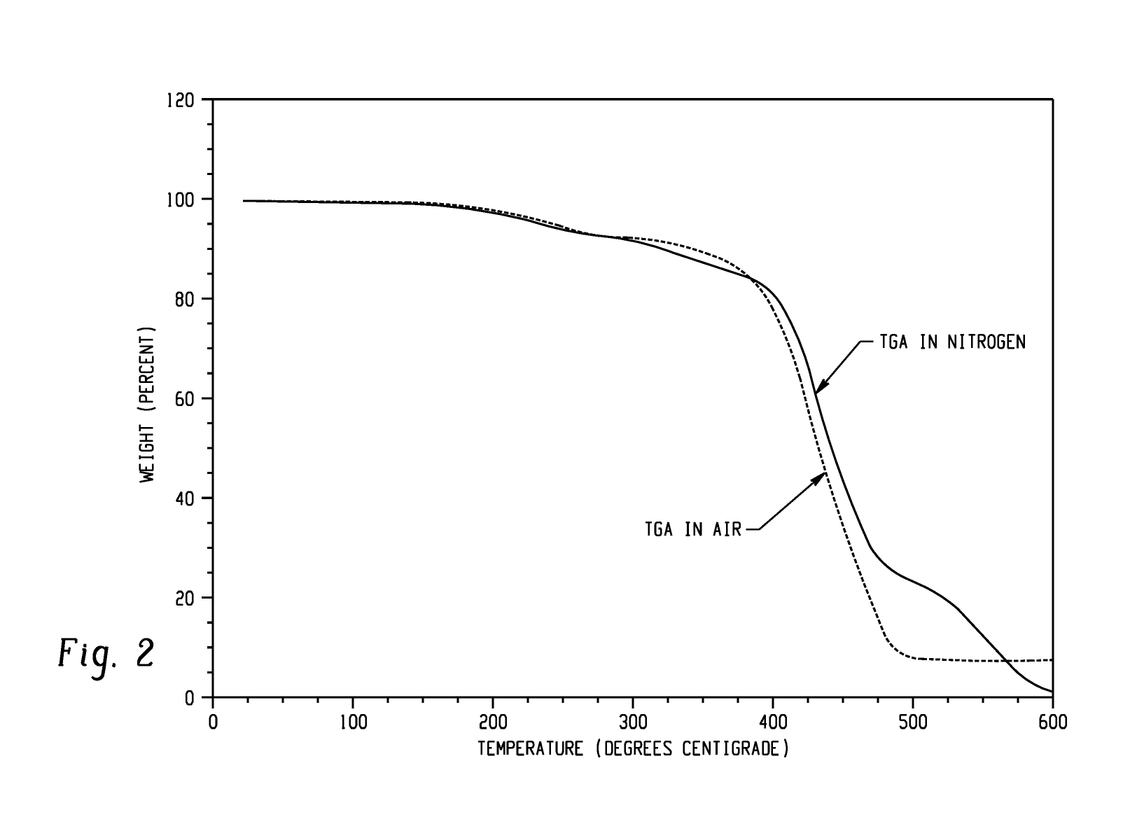

The foam of Example 3 exhibited a thermal stability as shown in FIG. 2, as determined by TGA, wherein the dotted line shows the TGA in air, and the solid line shows the TGA in nitrogen. As evident the onset of degradation was about 400° C. It is theorized that there may be less urethane groups due to a side reaction in which the polyol reacts with an anhydride intermediate to form a thermally stable ester linkage.

The foam materials of Examples 4-5 obtained the following properties:

TABLE 6

| Property | Example 4 | Example 5 |
|---|---|---|
| Density (pcf) | 10.3 | 5.46 |
| Thickness (mils) | 82 | 185 |
| CFD (psi) | 0.987 | 0.524 |
| Tensile (psi) | 17.9 | 6.4 |
| Elongation % | 12 | 6.2 |
| Tear (pli) | 2.067 | 1.286 |
| C-set (%) | 5.5 | 8.1 |

Thus, useful polyamide-urethane foam materials having advantageous properties can be effectively produced in accordance with the present invention.

### Example 6

Example 6 illustrates a rigid polyamide-urea foam produced in accordance with the present invention.

The formulation in Table 7 was used. A foam product can be prepared from this formulation as follows. All raw materials except the polyisocyanate (PAPI) are mixed together in a 1000-ml polypropylene beaker using an air mixer to stir. The raw materials are then put in the oven at 50° C. for ½ hr. The heated mixture is removed, re-stirred, the polyisocyanate (at room temperature) is added, and the composition is stirred for 30 seconds. The foam is allowed to cure at room temperature.

The cream time was 40 seconds; the TOC time was 1 minute, 18 seconds; and the gel time was 2 minutes, 8 seconds, and the tack-free time was 4 minutes.

TABLE 7

| Component | Description | Source | Amount (php) |
|---|---|---|---|
| Polyacid | Uniydyme ® 14 | | 100 |
| Catalyst 1 | Mg Dimerate (10%) | Synthesized | 3 |
| Amine Catalyst | UAX-1248 ® acid | | 0.5 |
| | blocked | | |
| | tertiary amine | | |
| Catalyst | Fomrez ® UL-1 | Momentive | 0.1 |
| | dibutyltin | | |
| | mercaptide | | |
| Surfactant | DC-1598 ® | Momentive | 2 |
| Water | Water | — | 3.5 |
| Polyisocyanate | PAPI ® 901 | Dow Chemical | 100 index |

The foam produced using the formulation of Table 7 above was a rigid polyurea-polyamide that exhibited improved thermal stability compared to a polyurethane foam. Two reactions occurred in the foam, the acid/isocyanate reaction to produce CO₂ and amide, and the water/isocyanate reaction to form a polyurea and CO₂. The resulting polyurea-polyamide foam, in the absence of urethane linkages, shows improved thermal stability compared to polyurethane foam. The TGA onset of degradation in nitrogen was about 400° C., a full 100-125° C. higher than the onset of degradation of many polyurethane foams.

### Example 7

This Example illustrates polyamide urethane urea rigid foam produced in accordance with the present invention. The formulation in Table 8 was used.

TABLE 8

| COMPONENT | DESCRIPTION | SOURCE | PHP |
|---|---|---|---|
| Polyol A | Terate ® HT 5503 polyol, a | In vista | 5 |
| | polyester polyol based | | |
| | on polyethylene terephthalate | | |
| Polyol B | Carpol ® MX-470 polyol, a | Carpenter | 15 |
| | Mannich base polyol | Co. | |
| Polyacid | Unidym ® 14 dimer acid | Arizona | 80 |
| | | Chemical | |
| Surfactant | Dabco ® DC5598 surfactant, a | Air | 6 |
| | non-hydrolyzable silicone | Products | |
| | surfactant designed for rigid | | |
| | foams | | |
| Water/acid | 2/1 citric acid/water blend | — | 7 |
| blend | | | |
| Catalyst | 10% Mg dimerate in dimer acid | | 4 |
| Co-catalyst | Niax ® Catalyst C5 tertiary | Momentive | 0.5 |
| | amine catalyst | | |
| | Total Amount (php) | | 112.5 |
| Polyisocyanate | PAPI 580 - Polymeric MDI, high | Dow | 130.3 |
| | polymeric methylene diphenyl | Chemical | |
| | isocyanate | | |
| | Isocyanate Index | | 115 |

The 10% Mg dimerate was made by adding 10 g of magnesium acetonylacetonate to 90 g of dimer acid, and heating to 150° C. for 5 hr, stirring occasionally.

The citric acid is a high melting powder (m.p.=156° C.), a small molecule with three carboxylic acids and one hydroxyl functionality, but is not very soluble in most raw materials. 100 g of citric acid can be added to 50 g of water in a glass jar and heated to 60 C with occasional stirring, the citric acid dissolve entirely in the water and stays dissolved at room temperature.

The 2/1 citric acid/water blend was made by adding 100 g of citric acid to 50 grams of water in a glass jar and heating in an oven at 60-80° C., for two hours stirring occasionally. The citric acid dissolves entirely in the water and stays dissolved at room temperature.

The polyols, water/citric acid blend, and catalysts were placed in a disposable 1000 ml polypropylene cup and blended for 60 seconds using an air mix at room temperature. The polymeric MDI was added, the stirrer placed on high, and the mixture blended for 10 seconds. The contents were then poured into a cardboard box and allowed to cure at room temperature overnight.

A polyamide-urethane-urea rigid foam was effectively produced. As measured, the foam density was 1.71 pounds per cubic feet.

### Example 8

Example 8 illustrates a polyamide urethane foam similar to Example 7 with the addition of flame retardant, using the formulation of Table 9.

TABLE 9

| | | | AMOUNT |
|---|---|---|---|
| COMPONENT | DESCRIPTION | SOURCE | (php) |
| Polyol C | Terate ® 5170 polyol | In vista | 10 |
| Polyol B | Carpol ® MX-470 polyol, | Carpenter | 10 |
| | a Mannich base polyol | Co. | |
| Polyacid | Unidym ® 14 dimer acid | Arizona | 80 |
| | | Chemical | |
| Surfactant | Dabco ® DC5598 surfactant, | Air | 6 |
| | a non-hydrolyzable silicon | Products | |
| | surfactant for rigid foams | | |
| Water | Water | — | 3 |
| Catalyst | 10% Mg dimerate in dimer | — | 4 |
| | acid | | |
| Amine co- | Niax ® Catalyst C5, a | Momentive | 0.5 |
| catalyst | tertiary amine catalyst | | |
| Flame | Saytex ® RB-7980 flame | M | 16.8 |
| Retardant 1 | retardant | Chemical | |
| Flame | Antiflame V-490 ® | M | 5.6 |
| Retardant 2 | | Chemical | |
| | Total | | 135.9 |
| Polyisocyanate | PAPI 580 - Polymeric MDI | | 130.2 |
| | Isocyanate Index | | 115 |

As in the previous example, the 10% Mg dimerate was made by adding 10 g of magnesium acetonylacetonate to 90 g of dimer acid, and heating to 150° C. for 5 hr, stirring occasionally, and the 2/1 citric acid/water blend was made by adding 100 g of citric acid to 50 grams of water and heating in an oven at 80° C., for two hours stirring occasionally. Once removed, the citric acid stayed in aqueous solution.

The polyols, water, catalysts and flame retardant were placed in a disposable 1000 ml polypropylene cup and blended for 60 seconds using an air mix at room temperature. The polymeric MDI was added, the stirrer placed on high and blended for 10 seconds. The content were then poured into a cardboard box and allowed to cure at room temperature overnight.

Thus, a polyamide-urethane-urea rigid foam was effectively produced. As measured, the foam density was 1.9 pounds per cubic feet.

### Comparative Examples 9-10

These Comparative Examples 9-10, compared to Example 7 above, employed the formulations of Table 10 below. In the case of Comparative Example 10, no water was present, only the amide blowing reaction. In the case of Comparative Example 9, the “water” reaction was present for blowing, but no acid for an amide blowing reaction. Example 7, as also described above, involved both the amide and water reaction.

TABLE 10

| | Comparative | Comparative | |
|---|---|---|---|
| Component | Example 9 | Example 10 | Example 7 |
| Terate ® HT 5503 | 80 | 0 | 0 |
| polyester polyol | | | |
| Terate ® 5170 polyol | 20 | 20 | 10 |
| Carpol ® MX-470 | 5 | 5 | 10 |
| polyol | | | |
| Unidym ® 14 dimer | 0 | 80 | 80 |
| acid | | | |
| Dabco ® DC5598 | 6 | 6 | 6 |
| silicone surfactant | | | |
| Water | 2.5 | 0 | 3 |
| 10% Mg dimerate | 0 | 4 | 4 |
| Niax ® C5 tertiary | 0.5 | 0.5 | 0.5 |
| amine catalyst | | | |
| Saytex ® RB-7980 | 16.8 | 16.8 | 16.8 |
| flame retardant | | | |
| Antiflame DEEP (V- | 5.6 | 5.6 | 5.6 |
| 490) ® flame retardant | | | |
| Dabco ® BL-17 | 0.5 | 0.5 | 0 |
| silicone surfactant | | | |
| Total | 136.9 | 138.4 | 135.9 |
| PAPI 580 | 127.1 | 81.3 | 130.2 |
| Isocyanate Index | 115 | 115 | 115 |
| density (pcf) | 3.47 | 2.75 | 1.9 |

As can be seen by the density results in Table 10 above, the source of the CO₂ and its reaction catalyst significantly affected the density, among other relevant properties.

### Examples 11-12

This Example illustrates polyamide urethane urea rigid foam using two different magnesium-containing catalysts in accordance with the present invention. The formulations in Table 11 were used.

TABLE 11

| | | | EX | EX | |
|---|---|---|---|---|---|
| COMPO- | | | 11 | 12 | Equiv. |
| NENT | DESCRIPTION | SOURCE | PPH | PPH | Wt. |
| Polyacid | Unidym ® 14 | Arizona | 100 | 100 | 193.7 |
| | dimer acid | Chemical | | | |
| Surfactant | Dabco ® DC5598 | Air | 3 | 3 | 0 |
| | surfactant, a non- | Products | | | |
| | hydrolyzable | | | | |
| | silicone | | | | |
| | surfactant designed | | | | |
| | for rigid foams | | | | |
| Catalyst 1 | 10% Mg (Terate ®) | Syn- | 5 | | 214.6 |
| | | thesized | | | |
| Catalyst 2 | 10% Mg dimerate | Syn- | | 5 | 311.7 |
| | | thesized | | | |
| Poly- | PAPI 580 - | Dow | 73.61 | 72.62 | 136.43 |
| isocyanate | Polymeric MDI, | Chemical | | | |
| | high polymeric | | | | |
| | methylene diphenyl | | | | |
| | isocyanate | | | | |

The first magnesium-containing catalyst was prepared by reacting magnesium acetylacetonate, Mg(acac), with Terate® HT 5503 polyol, a polyester polyol based on polyethylene terephthalate, commercially available from Invista. Specifically, the first catalyst was prepared by reacting 10 parts by weight Mg(acac) with 90 parts by weight of Terate® 5503 polyol at a temperature of 150° C. for five hours, stirring occasionally. The Terate® 5503 polyol has a hydroxyl number of 235 mg KOH/g, an acid number of 1 mg KOH/g, and a functionality of 2. The second magnesium-containing catalyst was prepared by adding magnesium acetylacetonate to dimer acid and then boiling off the acetyl acetone (acac), specifically reacting 90 parts dimer acid and 10 parts Mg(acac).

Each formulation was placed in a disposable 1000 ml polypropylene cup and blended for 60 seconds using an air mix at room temperature. The polymeric MDI was added, the stirrer placed on high, and the mixture blended for 10 seconds. The contents were then poured into a cardboard box and allowed to cure at room temperature overnight.

A polyamide-urethane rigid foam was effectively produced. The following results were obtained:

| RESULT | EX 11 | EX 12 PPH |
|---|---|---|
| Cream Time | 37 sec | 20 sec |
| TOC | 1 min 10 sec | 50 sec |
| Gel Time | 2 min 16 sec | 1 min 22 sec |
| Tack Free Time | 2 min 56 sec | 2 min 50 sec |

Accordingly, both magnesium-containing catalysts were similarly reactivity.

Ranges disclosed herein are inclusive of the recited endpoint and combinable (e.g., ranges of “up to about 25 wt. %, or, more specifically, about 5 wt. % to about 20 wt. %”, is inclusive of the endpoints and all intermediate values of the ranges of “about 5 wt. % to about 25 wt. %,” etc.). “Combination” is inclusive of blends, mixtures, alloys, reaction products, and the like. Also, “combinations comprising at least one of the foregoing” clarifies that the list is inclusive of each element individually, as well as combinations of two or more elements of the list, and combinations of one or more elements of the list with non-list elements. Furthermore, the terms “first,” “second,” and so forth, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the foam(s) includes one or more foams). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and is optionally present in other embodiments. In addition, it is to be understood that the described elements can be combined in any suitable manner in the various embodiments. As used herein, the terms sheet, film, plate, and layer, are used interchangeably, and are not intended to denote size.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to several embodiments thereof, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1. A polymer foam material formed from a foamable composition comprising:
an organic polyisocyanate component;
a polyacid component substantially reactive with the polyisocyanate to form an amide group in a polyamide-urethane copolymer;
a polyol component substantially reactive with the polyisocyanate component to form a urethane group in a polyamide-urethane copolymer;
a surfactant composition component; and
a catalyst system composition having substantial catalytic activity in the curing of said foamable composition, wherein the catalyst system composition comprises a catalyst compound comprising a cation of a metal, in a salt or ligand, which metal is selected from the group consisting of magnesium, cobalt, manganese, yttrium, Lanthanide Series metals, and combinations thereof;
wherein the curing reaction is associated with the elimination of carbon dioxide derived from a carboxy group in the polyacid and results in formation of amide groups in the copolymer component.

2. (canceled)

3. The polymer foam material of claim 1, wherein the catalyst compound is selected form the group consisting of magnesium hydroxide, magnesium oxide, magnesium acetate, magnesium stearate, magnesium dimerate, magnesium in association with an aromatic polyester polyol, and combinations thereof.

4. The polymer foam material of claim 1, wherein the catalyst compound comprises a magnesium (II) cation or a cobalt (II) cation.

5. The polymer foam material of claim 1, wherein the catalyst comprises a cation of a Lanthanide series metal selected from the group consisting of lanthanum, neodymium, dysprosium and combinations thereof.

6. The foam material of claim 1, wherein the catalyst compound is present in an effective amount, in association with the tertiary amine, to complete the curing reaction and foaming.

7. (canceled)

8. The foam material of claim 1, wherein the catalyst compound is present in an effective amount, in association with a second catalyst compound comprising another metal cation for promoting a urethane reaction

9.-18. (canceled)

19. The foam material of claim 1, wherein the polyol component comprises a polyether polyol, a polyester polyol PIPA polyol, PHD polyol, SAN polymer (polymer polyols containing respectively polyurethane, polyurea or styrene-acrylonitrile particles), hydrogenated or unhydrogenated polybutadiene polyol, acrylic polyol, polythioether polyol, hydroxyl-terminated silicone polyol, polycarbonate polyol, copolymers of the foregoing, and combinations comprising at least one of the foregoing polyols.

20. (canceled)

21. The foam material of claim 1, wherein the polyol component comprises a polyol polymer, for rigid foam, comprising sucrose-based, mannitol-based polyether polyol, polyester polyol or combination thereof.

22. (canceled)

23. The foam material of claim 1, wherein the polyol component comprises either a polyol triol, for resilient foam, having a number average molecular weight of 500 to 2500 or a polyester polyol having 3, 4, or 5 hydroxy groups on average.

24. (canceled)

25. The foam material of claim 24, wherein the polyol component, for resilient foam, comprises a caprolactone triol having a number average molecular weight of 500 to 2000.

26. The foam material of claim 1, wherein the polyol component comprises an ethylene oxide capped polyether oxide diol or a polyether oxide diol having a molecular weight from about 1000 to about 10000.

27. (canceled)

28. The foam material of claim 1, wherein the polyacid component comprises a C₃-C₈ diacid.

29. The foam material of claim 1, wherein the polyacid component comprises a hydrogenated or unhydrogenated dimer or trimer fatty acid having 12 to 60 carbon atoms.

30. (canceled)

31. (canceled)

32. The foam material of claim 1, wherein the foam material, as determined by TGA, does not begin to thermally degrade before 300° C., as determined by TGA.

33. A method of forming a tough thermally stable polymer foam comprising reacting an organic polyisocyanate component with a mixture comprising:
a polyol component substantially reactive with the organic polyisocyanate component to form urethane groups in a resulting polyamide-urethane copolymer,
a polyacid component substantially reactive with the organic polyisocyanate component to form an amide group in the polyamide-urethane copolymer;
a surfactant component; and
a catalyst system composition for curing the copolymer, comprising a catalyst compound having a cation of a metal, in a salt or ligand, which metal is selected from the group consisting of magnesium, cobalt, manganese, yttrium, Lanthanide Series metals, and combinations thereof;
wherein the curing reaction is associated with the elimination of carbon dioxide derived from a carboxy group in the polyacid and results in formation of amide groups in the copolymer; and
wherein foaming occurs at a temperature not more than 100° C.

34. The method of claim 33, wherein foaming occurs in a temperature range comprising a temperature of 10° C. to 90° C.

35.-38. (canceled)

39. A polymer foam material formed from a foamable composition comprising:
an organic polyisocyanate component;
a polyacid component substantially reactive with the polyisocyanate to form an amide group in a polyamide-urethane copolymer having urea groups];
a polyol component substantially reactive with the polyisocyanate component to form a urethane group in a polyamide-urethane copolymer;
at least 1% water; and
a surfactant composition component; and
a catalyst system composition having substantial catalytic activity in the curing of said foamable composition, wherein the catalyst system composition comprises a catalyst compound having a cation of a metal, in a salt or ligand, which metal is selected from the group consisting of magnesium, cobalt, manganese, yttrium, , Lanthanide Series metals, and combinations thereof;
wherein the curing reaction is associated with the elimination of carbon dioxide derived from a carboxy group in the polyacid, resulting in formation of amide groups in the copolymer, and with the elimination of carbon dioxide derived from an isocyanate group in the organic polyisocyanate component, resulting in the formation of urea groups in the copolymer.

40. (canceled)

41. The method of claim 33 for forming a tough thermally stable polymer foam comprising reacting an organic polyisocyanate component with a mixture comprising:
comprising reacting an organic polyisocyanate component with a mixture comprising:
a polyol component substantially reactive with the organic polyisocyanate component to form urethane groups in a resulting polyamide-urethane copolymer comprising urea groups,
at least 1 wt. %, based on the total weight of the composition, of water that is reactive with the organic polyisocyanate component to form urea groups in a resulting polyamide-urethane copolymer,
a polyacid component substantially reactive with the organic polyisocyanate component to form an amide group in the polyamide-urethane copolymer;
a surfactant component; and
a catalyst system composition for curing the copolymer, comprising a catalyst compound having a cation of a metal, in a salt or ligand, which metal is selected from the group consisting of magnesium, cobalt, manganese, yttrium, Lanthanide Series metals, and combinations thereof;
wherein the curing reaction is associated with the elimination of carbon dioxide derived from a carboxy group in the polyacid, resulting in formation of amide groups in the copolymer, and with the elimination of carbon dioxide derived from an isocyanate group in the organic polyisocyanate component, resulting in the formation of urea groups in the copolymer; and
wherein foaming occurs at a temperature not more than 100° C.

42. The polymer foam material of claim 1 formed from a foamable composition comprising the following, the total amount of which is 100 weight percent (wt. %):
20 to 60 wt. % of an organic polyisocyanate component;
20 to 60 wt. % of a polyacid component substantially reactive with the polyisocyanate to form an amide group in a polyamide-urethane copolymer;
10 to 33 wt. % of a polyol component substantially reactive with the polyisocyanate component to form a urethane group in a polyamide-urethane copolymer;
a surfactant composition component; and
of 0.5 to 5 wt. % of a catalyst system composition having substantial catalytic activity in the curing of said foamable composition, wherein the catalyst system composition comprises a catalyst compound comprising a cation of a metal, in a salt or ligand, which metal is selected from the group consisting of magnesium, cobalt, manganese, yttrium, Lanthanide Series metals, and combinations thereof;
wherein the curing reaction is associated with the elimination of carbon dioxide derived from a carboxy group in the polyacid and results in formation of amide groups in the copolymer component;
wherein a second different catalyst compound is present for promoting the urethane reaction; and
wherein the foam material, as determined by TGA analysis, does not begin to thermally degrade before 300° C.
